(19) United States
(12) Patent Application Publication
(10) Pub. No.: US 2006/0059073 A1
(43) Pub. Date: Mar. 16, 2006

(54) System and method for analyzing financial risk

(76) Inventor: Rebecca B. Walzak, Deerfield Beach, FL (US)

Correspondence Address: RUDEN, MCCLOSKY, SMITH, SCHUSTER & RUSSELL, P.A., 222 LAKEVIEW AVE, SUITE 800, WEST PALM BEACH, FL, 33401-6112, US

(21) Appl. No.: 11/227,339

(22) Filed: Sep. 15, 2005

Related U.S. Application Data
(60) Provisional application No. 60/610,089, filed on Sep. 15, 2004.

(51) Int. Cl. G06Q 40/00

(52) U.S. Cl. 705/35; 705/38

(57) ABSTRACT

The invention relates to the development of systems and methods for assessing a particular loan's financial risk due to process variations that have occurred in the underwriting and closing of the loan. The financial risk associated with a particular loan is expressed in terms of a quantitative score (a financial risk score) indicating the probability of the loan being defaulted on. The systems and methods of the invention provide purchasers of loans with a means to predict, in advance of purchasing a particular loan, the probability of the loan being defaulted on. Lenders who conduct quality control reviews and analyses of denied loan applications, as well as investors who wish to determine the regulatory risk associated with a loan, will also find use for the financial risk score generated by the systems and methods of the invention.

### CROSS-REFERENCE TO RELATED APPLICATION

The present application claims the priority of U.S. provisional patent application No. 60/610,089 filed Sep. 15, 2004.

### FIELD OF THE INVENTION

The invention relates generally to the fields of financial services and information technology. More particularly, the invention relates to a system and method for analyzing financial risk associated with a loan.

### BACKGROUND

In the financial services industry, the decision-making process of whether or not to grant a loan, such as a mortgage, is often rife with errors that result in an unacceptably high risk that the loan will be defaulted on. Current methods for measuring this risk involve ineffective, unsubstantiated, paper review programs that fail to produce meaningful assessments for lenders and purchasers of loans. Thus, there is a need for a cost-effective and accurate method for quantifying risk associated with a loan.

### SUMMARY

The invention relates to the development of systems and methods for assessing the financial risk of making a particular loan. The financial risk associated with a particular loan is expressed in terms of a quantitative score (a financial risk score) indicating the probability of the loan being defaulted on. The systems and methods of the invention provide purchasers of loans with a means to predict in advance of purchasing a particular loan, the probability of the loan being defaulted on. Lenders who conduct quality control reviews and analyses of denied loan applications, as well as investors who wish to determine the regulatory risk associated with a loan, will also find use for the financial risk score generated by the systems and methods of the invention.

Accordingly, the invention features a method for assessing a particular loan's financial risk. The method includes the steps of: (a) providing a predictive model based on a plurality of loans that have been deemed delinquent; (b) acquiring data pertaining to a borrower who has obtained a particular loan and data pertaining to the particular loan; (c) processing the acquired data to identify process variations; and (d) applying the predictive model to the processed data pertaining to the borrower and to the particular loan to generate a financial risk score for the particular loan. The method can further include the step (e) of use of the generated financial risk score by an entity who is interested in purchasing the particular loan to determine whether or not to purchase the particular loan. At least one of the steps is implemented on a computer, and in some methods, the steps (c) of processing the acquired data to identify process variations and (d) of applying the predictive model to the processed data pertaining to the borrower and to the particular loan to generate a financial risk score for the particular loan are performed using a computer-implemented algorithm. In preferred methods, the plurality of loans that have been deemed delinquent have been delinquent for at least 90 days. The particular loan can be a property or housing loan. The data pertaining to the borrower includes income information and credit information, while the data pertaining to the particular loan can include loan amount, interest rate, and type of loan, and information pertaining to each step involved in underwriting and closing the particular loan. Typically, the generated financial risk score is a number between 0 and 100.

The invention also features a system for assessing a particular loan's financial risk. The system includes a means for acquiring and processing data pertaining to a borrower who has obtained a particular loan and data pertaining to the particular loan, and a means for applying a predictive model based on a plurality of loans that have been deemed delinquent to the processed data to generate a financial risk score for the particular loan. The means for acquiring and processing data pertaining to a borrower who has obtained a particular loan and data pertaining to the particular loan can include a computer-implemented, rules-based statistical algorithm, which can be executed by an Artificial Intelligence system. The means for applying the predictive model to the processed data to generate a financial risk score for the particular loan can include a statistical algorithm (e.g., Maximum Likelihood Logistic Regression). The particular loan can be a property or housing loan. The data pertaining to the borrower includes income information and credit information, while the data pertaining to the particular loan includes loan amount, interest rate, and type of loan, and can further include information pertaining to each step involved in underwriting and closing the particular loan. The generated financial risk score typically is a number between 0 and 100. The system can further include a database storing thereon the data pertaining to the borrower, the data pertaining to the particular loan, and the predictive model.

Also within the invention is a computer-readable medium including instructions coded thereon that, when executed on a suitably programmed computer, execute the step of applying a predictive model based on a plurality of loans that have been deemed delinquent to processed data pertaining to a borrower of a particular loan and data pertaining to the particular loan to generate a financial risk score for the particular loan. In some embodiments, the plurality of loans that have been deemed delinquent have been delinquent for at least 90 days. The particular loan can be a property or housing loan. The data pertaining to the borrower includes income information and credit information, while the data pertaining to the particular loan includes loan amount, interest rate, and type of loan, and can further include information pertaining to each step involved in underwriting and closing the particular loan. The generated financial risk score can be a number between 0 and 100.

As used herein, the phrase “financial risk” means the risk that a particular loan, such as a mortgage, will be defaulted on.

By the phrase “financial risk score” is meant an indicator such as a symbol, color, or alphanumeric character (e.g., a number) that correlates with a quantity or other measure of financial risk, e.g., 0-100.

Unless otherwise defined, all technical and legal terms used herein have the same meaning as commonly understood by one of ordinary skill in the art to which this invention belongs. Although systems and methods similar or equivalent to those described herein can be used in the practice or testing of the present invention, suitable systems and methods are described below. All patent applications mentioned herein are incorporated by reference in their entirety. In case of conflict, the present specification, including definitions, will control. In addition, the systems, methods, and examples are illustrative only and not intended to be limiting. Other features and advantages of the invention will be apparent from the following detailed description, and from the claims.

### BRIEF DESCRIPTION OF THE DRAWINGS

FIG. 1 is a block diagram of a system of the invention.

FIG. 2 is a flowchart of a system of the invention.

FIG. 3 is a flowchart of a method of the invention.

### DETAILED DESCRIPTION

The invention encompasses systems and methods relating to assessing the financial risk involved with making, selling, or purchasing a particular loan by providing a predictive model that is based on a database of data pertaining to delinquent loans and applying this predictive model to data pertaining to the particular loan. In calculating the financial risk associated with a particular loan, a financial risk score that represents the probability that a particular loan will be defaulted on is generated by quantifying the risks associated with process variations, i.e., steps involved in underwriting and closing the loan that contain an error or that were performed incorrectly. This score allows lenders and the secondary market (e.g., purchasers of loans) to properly price loans before they are made, sold or purchased and also to implement quality control measures in their loan evaluation methods. By using the financial risk score of the invention to assess a particular loan that is to be purchased, the risk of default of the loan can be incorporated into the price, just like other risks are priced today. For example, the financial risk score can be used to help a lender identify which particular steps in its current loan underwriting and closing processes are not being executed correctly. The financial risk score can also be used by the secondary market to more accurately assess and price existing loan portfolios.

The below described exemplary embodiments illustrate adaptations of these systems and methods. Nonetheless, from the description of these embodiments, other aspects of the invention can be made and/or practiced based on the description provided below.

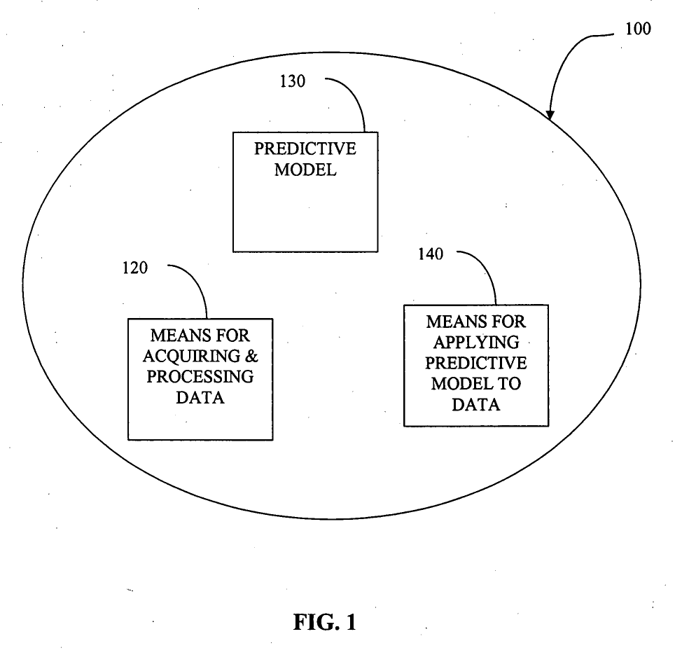

System For Assessing a Particular Loan's Financial Risk Within the invention is a system for assessing a particular loan's financial risk. Referring now to FIG. 1, there is shown a system 100 for assessing a particular loan's financial risk based on process variations that occurred in the processing of the particular loan. As will be explained in detail herein, the process variations of a particular loan are compared against a predictive model 130 of the system 100 to generate a financial risk score for the particular loan. To acquire data pertaining to loans and to facilitate the creation of a predictive model 130, the system 100 includes a means 120 for acquiring and processing data pertaining to at least one borrower who has obtained a particular loan and data pertaining to the particular loan. The means 120 for acquiring and processing data preferably includes a computer system, but can also include a non-computer-based system (e.g., a human operator). The means 120 for acquiring and processing data can receive data from a variety of data sources (e.g., external databases). For example, data may be received from credit reporting agencies, fraud databases, compliance databases, automated valuation models for establishing property values, income databases and land title databases. Many types of data can be acquired by the means 120 for acquiring and processing data. Data pertaining to a particular loan can include information about the borrower of the loan, such as borrower's name, social security number, birth date, telephone number, citizenship, monthly income, place of employment, type of employment, total assets, and total debt, as well as information about the particular loan such as loan type, amount of down payment, amount of monthly payment, and interest rate. For a non-exhaustive list of data pertaining to a particular loan and to the borrower of the particular loan that may be useful in the system 100 of the invention, see Table 1.

Once the desired data pertaining to a particular loan (or plurality of loans) is acquired by the means 120 for acquiring and processing data, the data is then processed to identify process variations that exist within the loan. Process variations are identified by applying a set of “IF-THEN” rules to the data, including the steps involved in the loan's underwriting and closing processes. For a non-exhaustive list of “IF-THEN” rules and their corresponding process variations useful in the system 100 of the invention, see Table 2. The “IF-THEN” rules are answered by either a “Y” or a “N,” a “Y” indicating that the step was performed correctly, and a “N” indicating that the step was performed incorrectly. For this purpose, the means 120 for acquiring and processing data in preferred embodiments includes a computer-implemented rules-based statistical algorithm, however, the means 120 can also include a manual, non-computer-based system for processing the data and identifying process variations. In some embodiments, an Artificial Intelligence system can be used to execute a rules-based statistical algorithm for processing the data and identifying process variations.

After data pertaining to a particular loan has been processed and process variations have been identified, a means 140 for applying the predictive model 130 to the data is used to generate a financial risk score for the particular loan. The means 140 for applying the predictive model to the processed data to generate a financial risk score for the particular loan typically includes a computer-implemented statistical method (e.g., Maximum Likelihood Logistic Regression (MLLR)). It is to be understood, however, that a financial risk score can also be generated using a non-computer-implemented statistical method. A financial risk score generated by the system 100 of the invention can be any appropriate indicator such as a symbol, color, or alphanumeric character (e.g., a number) that correlates with a quantity or other measure of financial risk. In the examples described below, the financial risk score is a number between 0 and 100, the lower the risk score, the higher the probability the loan will be defaulted on.

A financial risk score generated by the system 100 of the invention can be transmitted to any number of entities interested in the financial risk associated with a particular loan (e.g., a mortgage). Examples of entities to whom a financial risk score would be transmitted include Fannie Mae, Freddie Mac, HUD, GNMA, mortgage divisions of nationally and state chartered banks, thrifts, credit unions, independent mortgage companies, as well as firms securitizing mortgages such as Lehman, Credit Suisse, Goldman Sachs and UBS.

Using a system of the invention, any type of loan can be assessed, including, for example, property or housing loans (e.g., mortgages). In preferred embodiments, a system of the invention further includes a database storing thereon the data pertaining to the borrower, the data pertaining to the particular loan, as well as a predictive model for applying to these data.

### Method for Assessing a Particular Loan's Financial Risk

An exemplary method for assessing a particular loan's financial risk includes the steps of providing a predictive model based on a plurality of loans that have been deemed delinquent (e.g., payment overdue for at least 90 days); acquiring data pertaining to a borrower who has obtained a particular loan and data pertaining to the particular loan; processing the acquired data to identify process variations, and applying the predictive model to the processed data pertaining to the borrower and to the particular loan to generate a financial risk score (e.g., a number between 0 and 100) for the particular loan. Preferably, at least one of these steps is implemented on a computer. In some embodiments, all of these steps are implemented on a computer. For example, the step of applying the predictive model to the processed data pertaining to the borrower and to the particular loan to generate a financial risk score for the particular loan is performed using a computer-implemented algorithm. The particular loan can be any type of loan, but is typically a property or housing loan (e.g., a mortgage). The data pertaining to the borrower includes, for example, income information and credit information, while the data pertaining to the particular loan includes, for example, loan amount, interest rate, and type of loan. The data pertaining to the particular loan preferably further includes information pertaining to each step involved in underwriting and closing the particular loan. The method can further include the step of use of the generated financial risk score by an entity who is interested in purchasing the particular loan to determine whether or not to purchase the particular loan.

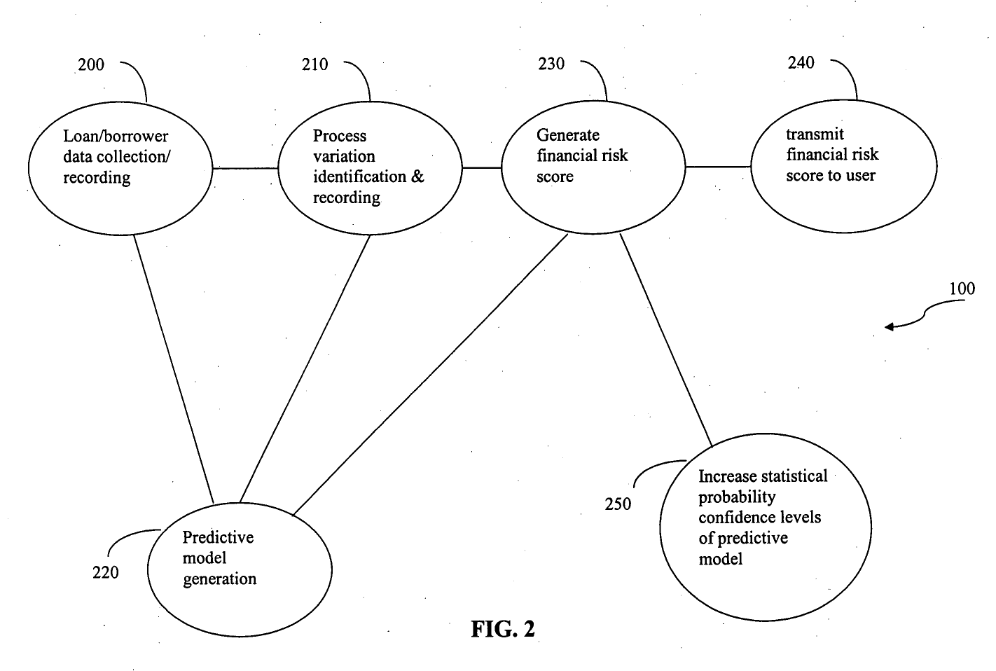

Referring now to FIG. 2, an overview of a method for assessing a particular loan's financial risk is shown. In step 200, data pertaining to (1) a plurality of loans (e.g., mortgages) that are deemed delinquent, (2) a particular loan (e.g., mortgage) to be assessed, and (3) the borrower(s) of the particular loan, are acquired, collected, and recorded, preferably in a database of the system. In step 210, process variations associated with each loan are identified, recorded, and processed. In step 220, the processed data pertaining to the plurality of loans deemed delinquent is used to generate a predictive model. In step 230, the predictive model is applied to the processed data pertaining to the particular loan to be assessed to generate a financial risk score. In step 240, the generated financial risk score for the particular loan to be assessed is transmitted to at least one entity who is a user of the system (e.g., a lender, a loan purchaser). In step 250, the statistical probability confidence levels of the predictive model are increased by acquiring and recording, preferably in the database of the system, additional data pertaining to additional loans (e.g., mortgages) that have been deemed delinquent and by the use of an Artificial Intelligence method known as case-based reasoning.

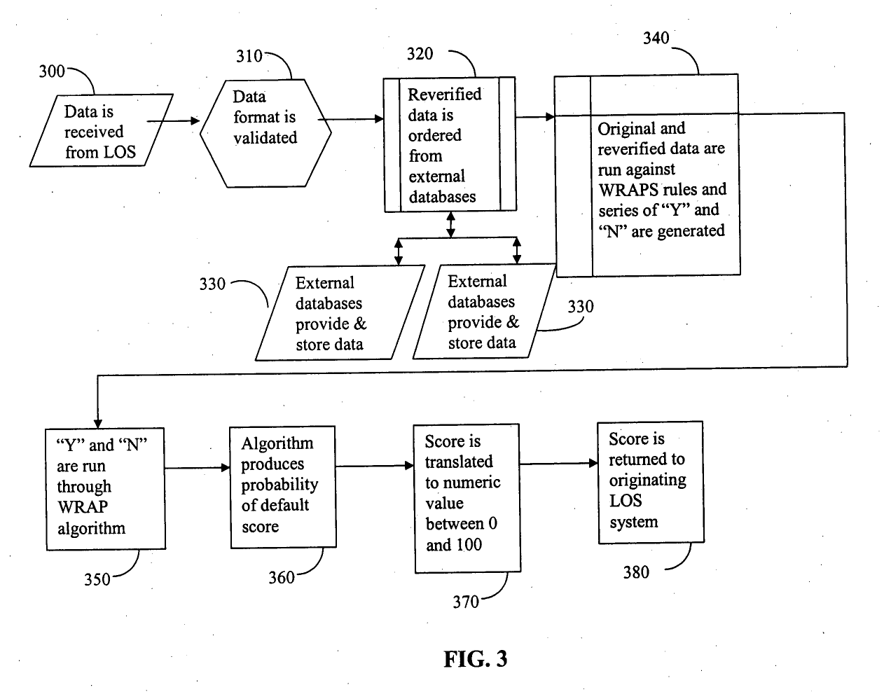

FIG. 3 illustrates an exemplary computer-based method of the invention for assessing a particular loan's financial risk once a predictive model has been generated. In step 300, data pertaining to a particular loan and to the borrower of the particular loan is acquired. This data is typically provided electronically by a loan origination system (LOS). In step 310, the format of the acquired data is validated. The data is preferably provided in an XML format. In order to establish if the information used in the underwriting and closing of the loan was accurate (e.g., reverifying the data), additional data is collected independently (and electronically) from various data providers (e.g., external databases 330) as shown in step 320. Loan file data elements include those pieces of information that identify the specifics of the loan such as the type of loan, the loan amount, the term of the loan, the property type, and location. In addition to these data elements, there are additional data that are particular to the processes involved in underwriting and closing the loan. These include, for example, the calculated income, the debts and debt payments, the property value, the amount of assets, and the ownership of the property. All of this combined data is evaluated according to universal underwriting and closing standards. Loan file data elements used in systems and methods of the invention are provided below in Table 1.

In step 340, these data elements are analyzed using a series of “IF-THEN” rules which are answered either “Y” or “N”. The “Y” indicates that the required sub-process was followed in the origination process. The “N” indicates that the process was not followed. Any process that was conducted incorrectly is noted as a process variation (e.g., the initial application was not completed as required, resulting in an unacceptable initial risk evaluation). This occurs for each sub-process involved in the loan approval process. As part of this analysis, each step that must be taken by an individual is identified and the data collected or used in each step of the process is established. The data can be compared to the “IF-THEN” rules manually (e.g., by a human operator) or by a computer running an appropriate program. Next, the risk that would be incorporated into the loan if a process variation occurred is identified. These risks are then documented as process variations. Many different process variations are typically used in systems and methods of the invention. Once the process variations are identified, the predictive model is applied to them in steps 350 and 360. The predictive model, by comparing the process variations to the loans that have been deemed delinquent, determines if there is a correlation between each process variation of the loan being assessed and the risk of default, as well as the strength of that correlation. The predictive model determines how strong the correlation is by considering each process variation in relation to the delinquent loans in the database having those process variations. For example, a loan with a process variation related to the initial application not being complete may have a score of 75 if it is a 97% LTV (Loan-To-Value). If that same variation is found in another loan with an LTV of 60%, the score may be 99. As a result, the predictive model of the system estimates the likelihood that a loan with a given process variation will be defaulted on.

Based on the quantitative results derived from linking loan performance (whether or not a loan is defaulted on) and process variations, the financial risk score is generated in step 370. This score reflects the probability that the loan will be defaulted on and in one example of a scoring system, ranges from “0” to “100” with “0” having the highest probability of default. In an exemplary embodiment, the loans with a score of 0 will have a 76.4% chance of defaulting while those loans with a score of 90 or above will have less than a 13% chance of defaulting. Once the score has been calculated, it is typically sent electronically to a lender or investor in step 380.

### Predictive Model for Assessing a Particular Loan's Financial Risk

The systems and methods of the invention involve a predictive model that identifies and quantifies incremental risk attributed to process variations in a loan, generating a likelihood of default that is then reflected as a financial risk score. The exemplary predictive model described herein was developed by establishing which process variations impact loan performance (i.e., whether or not the loan is defaulted on), grouping these process variations into classes of information (e.g., information pertaining to borrower credit, information pertaining to borrower income, etc.), and assigning incremental risk weights to the process variations. Different predictive models may be created for different types of financial assessments and for different types of loans.

As a first step in developing an exemplary predictive model, data elements pertaining to a plurality of mortgages that were more than 90 days delinquent were collected, including, for example, loan amount, loan purpose, occupancy type, interest rate, loan program, and FICO score of the borrower, and stored in a database of the system. Some additional data elements that were used in generating the exemplary predictive model of the invention are listed in Table 1. Any loan that was delinquent due to an uncontrollable factor, such as death of the borrower, was not included. Next, the loans were reviewed using a series of “IF-THEN” rules based on universal underwriting standards and specific loan requirements defined by investors who purchase the loans (the secondary market) to determine if each step in the underwriting and closing processes was performed correctly. For each step that was performed correctly, a “Y” was assigned to that step, and for each step that was performed incorrectly, an “N” was assigned to that step. Each step that was performed incorrectly is known as a process variation. For example, an important step in the mortgage underwriting process is determining if the applicant (e.g., the future borrower) can afford to make the monthly housing payment required by the lender. This step involves several substeps including obtaining the income information from a secondary source such as pay stubs or tax returns, calculating the amount of monthly income this represents, and dividing the new housing payment by the amount of income to obtain the “housing ratio.” Next, this housing ratio must be compared to the acceptable housing ratio limit for the loan product being requested. If the housing ratio is at or below the acceptable limit, then the loan can be approved. If the housing ratio is above the acceptable limit, it should not be approved.

Once the process variations were identified, they were grouped into classes of information dependent on the type of process variation. Different classes of process variations include those pertaining to an applicant's credit, those pertaining to an applicant's income, etc. These groups of process variations were then assigned different weights (values that reflect that group's contribution to the probability of default) that incrementally contribute to the financial risk score of a loan. For example, all process variations related to credit were grouped together and assigned a particular weight while groups of process variations related to less important factors such as insurance coverages, HMDA data, and company-specific documents, for example, were assigned lower weights. The grouped process variations were then normalized for risk factors such as, for example, loan type, loan amount and the ratio of the loan amount to the value of the property (LTV).

Using a statistical technique based on a correlation of operational variances to loan performance known as MLLR, a technique commonly used to associate exception groupings, such as income, with actual loan performance (e.g., whether or not the loan defaults), the predictive model identifies which mortgage loan process variations actually lead to an increased probability of a mortgage loan becoming more than 90 days delinquent. Methods and applications of MLLR are described in Applied Logistic Regression by David Hosner and Stanley Lemeshow, 2^{nd} ed., Wiley-Interscience, Hoboken, N.J., 2000; Logistic Regression by David G. Keinbaum, Mitchell Klein, and E. Rihl Pryor, 2^{nd} ed., Springer, New York, N.Y., 2002; and A preliminary investigation of maximum likelihood logistic regression versus exact logistic regression, an article from: The American Statistician (HTML format) by Elizabeth N. King and Thomas P. Ryan, American Statistical Association Press, Alexandria, Va., vol. 56, issue 3, Aug. 1, 2002.

The predictive model also determines the impact or trade-off between multiple process variations on future loan performance (whether or not the loan will be defaulted on). In other words, using a statistical methodology and a paired file analysis approach, the model identifies and quantifies incremental risk weights attributed to groups of process variations. When the predictive model is being used to assess a particular loan, incremental weights assigned to the loan's process variations are summed and then through the model's established correlations between process variations and the expected default probability, a financial risk score for the particular loan is generated. In a typical embodiment, the higher the financial risk score for a particular loan, the lower the default probability is for that loan.

The statistical probability confidence levels of the predictive model can be increased through at least two methods. A first method is the addition of defaulted loans into the predictive model's database. This involves identifying loans that have failed to perform as expected and are more than 90 days delinquent and then evaluating them using the “IF-THEN” rules (Table 2) described above. Once this is completed, the predictive model is applied to the process variations found in these defaulted loans and the results are added to the database of the system. For example, if 100% of the defaulted loans in the database have a miscalculated applicant income in their findings, any loans being assessed that have this process variation will have a greater probability of default.

A second method for increasing the statistical probability confidence levels of the predictive model is the use of an Artificial Intelligence method called case-based reasoning. Case-based reasoning is the process of solving a new problem by retrieving one or more previously experienced cases, reusing the case in one way or another, revising the solution based on reusing a previous case, and retaining the new experience by incorporating it into the existing knowledge-base (case-base). Case-based reasoning approaches and methods are described in, for example, A. Aamodt and E. Plaza, Artificial Intelligence Communications, vol. 7:1, pages 39-59, 1994. A case-based reasoning approach for increasing the statistical probability confidence levels of the predictive model will replicate the steps included in the defaulted loan evaluation process described above while allowing for the creation of various cases based on previous findings. These created cases can then be added to the database of existing defaulted loans to further build the confidence of the financial risk score results.

### Use of the Financial Risk Score

Many uses for the financial risk score generated by systems and methods of the invention are envisioned. This score, in combination with other loan attributes, can assist an investor in determining if and for how much a loan will be purchased and can assist a lender who is conducting quality control or regulatory compliance reviews of loans or loan portfolios. In addition to assisting individuals or entities in the secondary market with determining loan prices (see Example 2), a financial risk score according to the invention also has applications for all consumer lending companies such as those issuing auto loans, student loans, personal loans, credit cards or other such loan types. In addition to the origination processes, the financial risk score can also be applied to the servicing processes within the consumer lending industry. The financial risk score can be used by individuals or entities in the primary market (i.e., lenders) for conducting quality control reviews. For example, agencies and investors currently require that only a 10% sample of all loans closed in any month be randomly selected and reviewed. Techniques currently used to conduct such reviews are inefficient and inaccurate. A financial risk score generated by systems and methods of the invention provides a tool for analyzing how many loans are being produced that have a higher probability of default, where they are coming from, and what loan origination and/or closing processes need to be modified. By using a system and method of the invention, lenders can review 100% of their loan files at a cost estimated to be less than what they pay today to review only 10% of their loan files. Use of a financial risk score provides a timely and efficient analytical analysis to replace the ineffective and inefficient quality control processes that are currently used.

A further application for a financial risk score according to the invention is for analyzing denied loan applications. Serious penalties are associated with a lender's failure to meet fair lending standards. Therefore, lenders must be able to evaluate their denied loans to determine that no discriminatory lending practices exist. Using systems and methods of the invention, each denied loan can be assigned a financial risk score and this score can be compared to the financial risk scores of loans with identical loan characteristics that were approved. This allows lenders to identify any processes that create the perception of discriminatory lending and to modify that process accordingly or identify evidence to support their underwriting decisions.

With the increasing number of regulations and a growing concern by regulators of the financial services industry, both lenders and investors are continually attempting to ensure all regulatory requirements are met. Because the process variations identified with regulatory compliance are included in the predictive model described herein, a review of regulatory requirements can be performed. The resulting financial risk score can then be used by investors to determine the regulatory risk of a particular loan along with the risk of default of that particular loan. Lenders with overall lower financial risk scores may be seen as having a higher chance of regulatory issues by investors who can then charge these lenders appropriately to cover the risks being assumed by the secondary market.

Yet another use for a financial risk score according to the invention arises when a loan has been sold into the secondary market. In this situation, investors typically require yet another file review of 10% of the loans included in any securitization. These reviews, however, are rarely performed correctly and consistently. By using a financial risk score according to the invention, the loans selected for securitization can be subjected to a consistent and relevant analysis. This analysis can be conducted quickly and efficiently, thereby expediting the securitization process and reducing costs.

### Computer-Readable Medium

The methods and systems of the invention are preferably implemented using a computer equipped with executable software to automate some of the methods described herein. Accordingly, various embodiments of the invention include a computer-readable medium having instructions coded thereon that, when executed on a suitably programmed computer, execute one or more steps involved in the method of the invention, e.g., a step of applying a predictive model based on a plurality of loans that have been deemed delinquent to processed data pertaining to a borrower of a particular loan and data pertaining to the particular loan to generate a financial risk score for the particular loan. Examples of suitable such media include any type of data storage disk including a floppy disk, an optical disk, a CD-ROM disk, a DVD disk, a magnetic-optical disk; read-only memories (ROMs); random access memories (RAMs); electrically programmable read-only memories (EPROMs); electrically erasable and programmable read only memories (EEPROMs); magnetic or optical cards; or any other type of medium suitable for storing electronic instructions, and capable of being coupled to a system for a computing device.

### Database

The system preferably includes a database for storing information on individual loans (e.g., defaulted loans). The database is also useful for storing cases that were created based on previous findings using case-based reasoning. The database of the system is capable of receiving information (e.g., underwriting information, closing information, loan file data elements, such as FICO score of borrower and income information, etc.) from external sources. The database can be protected by a fire wall, and can have additional storage with back-up capabilities.

TABLE 1
Data Elements

Loan defaulted reporting frequency type
Loan delinquency advance days count
Loan delinquency effective date
Loan delinquency event date
Loan delinquency event type
Loan delinquency event type other description
Loan delinquency history period months count
Loan delinquency reason type
Loan delinquency reason type other description
Loan delinquency status date
Loan delinquency status type
SFDMS automated default processing code identifier
Closing agent type
Closing agent address
Closing cost contribution amount
Closing cost funds type
Closing date
Closing instruction condition description
Closing instructions condition met indicator
Closing instructions condition sequence identifier
Closing instructions condition waived
Closing instruction termite report required indicator
Condominium rider indicator
Flood insurance amount
Acknowledgement of cash advance against non homestead
property indicator
Disbursement date
Document order classification type
Document preparation date
Escrow account activity current balance amount
Escrow account activity disbursement month
Escrow aggregate accounting adjustment amount
Escrow collected number of months
Escrow item type
Escrow completion funds
Escrow monthly payment amount
Escrow specified HUD 1 Line Number
Escrow waiver indicator
Fund by date
Funding cutoff time
Funding interest adjustment day method type
Hazard insurance coverage type
Hazard insurance escrowed indicator
Hours documents needed prior to disbursement count
HUD1 cash to or from borrower indicator
HUD 1 cash to or from seller indicator
HUD1 conventional insured indicator
HUD 1 lender unparsed name
HUD 1 line item from date
HUD 1 line item to date
HUD1 settlement agent
HUD 1 settlement date
Interest only monthly payment amount
Interim interest paid from date
Interim interest paid number of dates
Interim interest total per diem amount
Late charge rate
Late charge type
Legal vesting and comment
Legal vesting plant date
Legal and vesting title held by name
Legal validation indicator
Lender loan identifier
Lender documents ordered by name
Lender funder name
Lien description
Loan actual closing date
Loan scheduled closing date
Lock expiration date
Loss payee type
Note date
Note rate percent
One to four family rider indicator
Security instrument
Title ownership type
Title report items description
Title report endorsements description
Title request action type
Title response comment
Vesting validation indicator
Borrower qualifying income amount
Current employment months on job
Current employment time in line of work
Current employment years on job
Current income monthly total amount
Employer name
Employer city
Employer state
Employer telephone number
Employment self-employed indicator
Employment current indicator
Employment position description
Employment primary indicator
Employment reported date
Income employment monthly amount
Income type
Borrower funding fee percent
Borrower paid discount points total amount
Borrower paid FHA VA closing costs amount
Borrower paid FHA VA closing costs percentage
Compensation amount
Compensation paid by type
Compensation paid to type
Compensation percent
Compensation type
Application fees amount
Closing preparation fees
Refundable application fee indicator
Base loan amount
Below market subordinate financing indicator
Property address: #, street, city, county, state, zip
Borrower MI termination date
Borrower power of attorney signing capacity description
Borrower requested loan amount
CAIVRS identifier
Combined LTV ratio percent
Concurrent origination indicator
Conditions to assumability indicator
Conforming indicator
Convertible Indicator
Correspondent Lending Company name
Current LTV ratio
Down payment amount
Down payment source
Down payment option type
Escrow payment frequency type
Escrow payments payment amount
Escrow premium amount
Escrow premium paid by type
Estimated closing costs amount
Full prepayment penalty option
GSE refinance purpose type
Lender case identifier
Loan documentation description
Loan documentation level type
Loan documentation level type other
Loan documentation subject type
Loan documentation type
Mortgage license number identifier
Mortgage broker name
One to four family indicator
Secondary financing refinance indicator
Second home indicator
Bankruptcy
Borrower non obligated indicator
Credit bureau name
Credit business type
Credit comment code
Credit comment type
Credit file alert message adverse indicator
Credit file alert message category
Credit file borrower age years
Credit file borrower alias first name
Credit file borrower alias last name
Credit file borrower birthdate
Credit file borrower first name
Credit file borrower last name
Credit tile borrower residence full address
Credit file borrower SSN
Credit file borrower address
Credit file borrower employment
Credit file result status type
Credit file variation type
Credit inquiry name
Credit inquiry result type
Credit liability account balance date
Credit liability account closed date
Credit liability account identifier
Credit liability account opened date
Credit liability account ownership type
Credit liability account status date
Credit liability account status type
Credit liability account type
Credit liability charge off amount
Credit liability consumer dispute indicator
Credit liability current rating code
Credit liability current rating type
Credit liability derogatory data indicator
Credit liability first reported default date
Credit liability high balance amount
Credit liability high credit amount
Credit liability highest adverse rating code
Credit liability highest adverse rating date
Credit liability highest adverse rating type
Credit loan type
Credit public record bankruptcy type
Credit public record consumer dispute indicator
Credit public record disposition date and type
Credit score date
Credit score model type name
Credit score value
Loan foreclosure or judgment indicator
Monthly rent amount
Monthly rent current rating type
ARM qualifying payment amount
Arms length indicator
Automated underwriting process description
Automated underwriting system name
Automated underwriting system result value
Contract underwriting indicator
FNM Bankruptcy count
Housing expense ratio percent
Housing expense type
HUD adequate available assets indicator
HUD adequate effective income indicator
HUD credit characteristics
HUD income limit adjustment factor
HUD median income amount
HUD stable income indicator
Lender registration identifier
Loan closing status type
Loan manual underwriting indicator
Loan prospector accept plus eligible indicator
Loan prospector classification description
Loan prospector classification type
Loan prospector key identifier
Loan prospector risk grade assigned type
MI and funding fee financed amount
MI and funding fee total amount
MI application type
MI billing frequency months
MI cancellation date
MI certification status type
MI company type
MI coverage percentage
MI decision type
MI l loan level credit score
MI renewal premium payment amount
MI request type
MI required indicator
Mortgage score type
Mortgage score value
Mortgage score date
Names document drawn in type
Payment adjustment amount
Payment adjustment percent
Payment schedule
Payment schedule payment varying to amount
Payment schedule total number of payment count
Periodic late count type
Periodic late count 30-60-90-days
Present housing expense payment indicator
Proposed housing expense payment amount
Subordinate lien amount
Total debt expense ratio percent
Total liabilities monthly payment amount
Total monthly income amount
Total monthly PITI payment amount
Total prior housing expense amount
Total prior lien payoff amount
Total reserves amount
Total subject property housing expense amount
Application taken type
Estimated closing costs amounts
Gender type
GSE title manner held description
Homeowner past three years type
Interviewer application signed date
Interviewers employer city
Interviewers name
Interviewers employer name
Landlord name
Landlord address
Loan purpose type
Estimated closing date
Mortgage type
Non owner occupancy rider indicator
Manufactured home indicator
Outstanding judgments indicator
Party to lawsuit indicator
Presently delinquent indicator
Purchase credit amount
Purchase credit source type
Purchase credit type
Purchase price amount
Purchase price net amount
Refinance cash out determination type
Refinance cash out percent
Refinance improvement costs amount
Refinance improvements type
Refinance including debts to be paid off amount
Refinance primary purpose type
Third party originator name
Third party originator code
Title holder name

TABLE 2
Process Variations

| | PROCESS | | |
|---|---|---|---|
| QUESTIONS | VARIATIONS | DATA | RULES |
| Was the initial | Initial application | B-Name, Co- | Look at date of |
| application complete | was not completed | Name; SS#, | application. Look at |
| with all required | as required resulting | DOB, present | history of data fields, |
| information obtained | in an unacceptable | address, | If designated data fields |
| by the loan officer? | initial risk | income, liquid | are not complete, OR, |
| | evaluation. | assets, source | DTI or FICO score |
| | | of funds, | exceed product |
| | | product type, | guidelines AND loan is |
| | | occupancy | approved, indicate “N” |
| | | type, estimated | and add error code |
| | | P&I, DTI, | IA0001 to listing. If |
| | | disposition. | designated data fields |
| | | | are complete and meet |
| | | | product guidelines and |
| | | | the loan is approved |
| | | | indicate “Y” |
| Was the government | HMDA data was | Application | Look at application |
| monitoring section | not gathered | type; Ethnicity, | type. Look at history |
| complete and | correctly. | race gender. | of ethinicity and/or race |
| consistent with the | | | and gender and |
| type of application | | | application date. If |
| taken? | | | “face to face” |
| | | | application type |
| | | | checked, ethnicity, |
| | | | race, ethnicity and race, |
| | | | gender must be |
| | | | completed for each |
| | | | borrower. If they are, |
| | | | indicate “Y” If not, |
| | | | indicate “N” and add |
| | | | error code IA0002. |
| | | | If “Telephone” |
| | | | application type is |
| | | | checked, Either |
| | | | “borrower does not |
| | | | wish to provide this |
| | | | information” OR |
| | | | ethnicity, race, |
| | | | ethnicity and race, |
| | | | gender must be |
| | | | completed for each |
| | | | borrower. If not, |
| | | | indicate NO and add |
| | | | error code IA0002. |
| | | | If “Mail” or “Internet” |
| | | | is checked no error. |
| | | | Indicate “y” |
| Did the final signed | The data in the final | B-Name, Co- | Compare data in |
| application reflect the | application fields is | Name; SS#, | original fields with data |
| information used to | consistent with the | DOB, Present | source of printed 1008 |
| evaluate and make a | data used on the | address, | and/or MCAW or VA |
| decision on the loan? | underwriting | income, liquid | underwriting analysis. |
| | evaluation screens | assets, source | If any data field is |
| | OR AUS data. | of funds, | different, indicate NO |
| | | product type, | and add error code |
| | | PITI, DTI, | IA0003. |
| | | property value, | |
| | | total liabilities, | |
| | | occupancy | |
| | | type, purpose, | |
| | | FICO score, | |
| | | ETC. | |
| Is there evidence the | The initial | Calculate | If print date of |
| initial Disclosure | disclosure package | “Required” | “Disclosure Package” is |
| package was provided | was not sent out | date by adding | greater than “Required |
| to borrower within 3 | within 3 business | 3 business | Date”, indicate NO and |
| business days of | days of application. | days to | add error code |
| receipt of application? | | application | “ID0001. If date is |
| | | date. Calendar | within required date |
| | | should | indicate “Y”. |
| | | disregard | |
| | | Saturday, | |
| | | Sunday and/or | |
| | | Federal | |
| | | Holidays. | |
| | | Once date is | |
| | | calculated, | |
| | | compare this | |
| | | date to the | |
| | | print date of | |
| | | the first Good | |
| | | Faith Estimate, | |
| | | the Initial TIL, | |
| | | the ECOA | |
| | | Notice, | |
| | | Servicing | |
| | | Transfer | |
| | | Notice, Right | |
| | | to Receive an | |
| | | Appraisal | |
| | | Notice, | |
| | | Mortgage | |
| | | Insurance | |
| | | Notice, | |
| | | Product Notice | |
| | | and Other | |
| | | documents | |
| | | included in | |
| | | “Initial | |
| | | Disclosure | |
| | | Package”. | |
| If required, was a | The required | Product type, | If product code matches |
| product disclosure | product disclosure | Product | the print code for the |
| provided that | was not provided or | disclosure type | disclosure type, |
| accurately reflected | was the incorrect | from print | indicate “Y”. If not |
| the terms and | disclosure. | field. | indicate “N”. |
| conditions of the loan | | | |
| requested? | | | |
| Was the Good Faith | The Good Faith | Product type, | Compare fees in table |
| Estimate completed | Estimate did not | loan amount, | with fees included in |
| properly and fees | reflect the accurate | property | print program for Good |
| shown reflective of the | fees to be charged. | address, city, | Faith Estimate. If they |
| acceptable fees and | | state, fees from | match, indicate “Y”. If |
| charges for the state in | | fee table for | they do not match, |
| which the property is | | specific city | indicate “N”. |
| located? | | and state, fees | |
| | | from fee table | |
| | | for standard | |
| | | processing fees | |
| | | and pricing | |
| | | fees including | |
| | | pricing loan | |
| | | adjustments. | |
| Does the file contain | All required state | State code for | If all documents with |
| evidence all applicable | disclosures were not | property. All | state code consistent |
| State required | provided to the | documents | with the property state |
| disclosures were | applicant. | with | code are found in print |
| provided to the | | corresponding | program, indicate “Y”. |
| applicant? | | state code. | IF they are n not found, |
| | | | indicate “N”. |
| Does file contain an | The credit report | Credit report | If “credit report type” |
| credit report | used in the | type required | from product guidelines |
| acceptable for the | application process | from product | matches “credit report |
| product type | was inadequate for | guidelines. | type” form order table, |
| requested? | the product | Credit report | indicate “Y”. If it does |
| | selected. | type from | not, indicate “N”. |
| | | credit report | |
| | | order table. | |
| Were all credit | Credit obligations | Listing of | Calculate all monthly |
| obligations included | on the credit report | credit | credit obligations from |
| on the application | were different from | obligations, | the application data. |
| consistent with the | the credit | amounts owing | Calculate all monthly |
| credit report? | obligations | and monthly | credit obligations from |
| | provided on the | payments from | the credit report. |
| | application. | application | Compare the two |
| | | data. Listing | results. If the credit |
| | | of credit | obligations from the |
| | | obligations, | application is equal to |
| | | amounts and | or greater than the |
| | | monthly | calculations from the |
| | | payments from | credit report indicate |
| | | credit report. | “Y”. If the monthly |
| | | | obligations from the |
| | | | application is less than |
| | | | the credit report |
| | | | indicate “N”. |
| Did any of the | Credit report | DTI limit in | If recalculated DTI is |
| discrepancies have a | discrepancies | product | greater than the DTI in |
| negative impact on the | impacted the DTI | guidelines. | product guidelines |
| overall DTI ratio? | ratio. | Calculated | indicate “Y”. If |
| | | DTI. Add | recalculated DTI is |
| | | proposed | equal to or less than |
| | | housing | product guidelines, |
| | | payment from | indicate “N”. |
| | | initial | |
| | | application to | |
| | | the monthly | |
| | | obligations | |
| | | obtained from | |
| | | the credit | |
| | | report. Divide | |
| | | this total by | |
| | | the total | |
| | | income to | |
| | | obtain the DTI. | |
| Were all public record | Public records | Public records | If file has public record |
| and inquiries reviewed | and/or inquires were | and inquires | inquires in fraud report |
| and acceptable | not resolved. | from credit | as action items, and |
| explanations obtained? | | report. Public | they have not been |
| | | record data | tagged as resolved, |
| | | from fraud | indicate “Y”. If public |
| | | report with | record inquires are |
| | | action item | shown as resolved, |
| | | notice | indicate ““N”. |
| | | indicated. | |
| If credit report | Adequate credit | Calculate the | If number of credit |
| contained inadequate | references were not | number of | references is less than |
| credit references, were | obtained. | credit | four, indicated “N”. If |
| additional references | | obligations on | number obtained were |
| obtained? | | the credit | greater than four, |
| | | report. | indicated “Y”. |
| Was credit score | Credit score was | Compare the | If credit score from |
| consistent with | inadequate for | credit score in | credit report is less than |
| product requested and | approved product. | the product | product guideline |
| approved? | | guideline | indicate “N”. If credit |
| | | against the mid | score is greater than or |
| | | range credit | equal to credit score |
| | | score from the | guideline indicate “Y”. |
| | | credit report. | |
| Does the credit report | Credit review | Review list of | If credit issues on fraud |
| reflect red flags that | indicated red flags | credit issues in | report not resolved is |
| were resolved? | that were not | fraud report. | equal to “0” indicated |
| | resolved. | Count those | “N”. If credit issues |
| | | that have been | not resolved is greater |
| | | “checked off” | than “0” indicate “Y”. |
| | | as resolved. | |
| Does the file contain | Documentation of | Documentation | If documentation type = NINA |
| the income | income/employment | type, income | or SISA, OR if |
| documentation as | was inadequate for | and | other documentation |
| required in the product | the product. | employment | type and income and |
| guidelines? | | documents | employment documents |
| | | checked | shown as received |
| | | | indicate “N”. If other |
| | | | documentation type and |
| | | | no documents shown as |
| | | | received indicate “Y”. |
| Was the source of | Income source was | Total income | If both income fields |
| income shown on the | inconsistent with | calculated for | are consistent or if |
| application consistent | verified income | each borrower | variance between them |
| with the source of | source. | in application | is less than 2.5% |
| income verified? | | data. Total | indicate “N”. If income |
| | | income | fields are inconsistent |
| | | calculated for | and the inconsistency is |
| | | each borrower | greater than 2.5%, |
| | | in | indicate “Y”. |
| | | underwriting | |
| | | fields. | |
| Was the income stated | Income used in | Fraud | If fraud exception |
| on the application | underwriting was | exception on | exists indicate “Y”. If |
| reasonable for the type | not reasonable for | income. | there is no fraud |
| and location of | the type and | | exception, indicate “N”. |
| employment? | location of | | |
| | employment. | | |
| Were all fraud | Income review | Fraud | If fraud exception |
| indicators associated | indicated red flags | exception on | exists and is not shown |
| with income and | that were not | income that | as resolved, indicate |
| employment resolved? | resolved. | was not | “Y”. If there is no |
| | | indicated as | fraud exception or if |
| | | resolved. | fraud exception is |
| | | | resolved, indicate “N”. |
| Using all sources of | Income was | Data entered | Take income from each |
| verification, was the | calculated | into | borrower and |
| income calculated | incorrectly. | underwriter | recalculate. Take total |
| correctly by the | | system for | income from each |
| underwriter? | | income for | borrower and add |
| | | each borrower. | together. If income |
| | | Tax return data | matches total income |
| | | received and | from underwriting data |
| | | employment | indicate “Y”. If total |
| | | type equal self- | do not match, indicate |
| | | employed. | “N”. If borrower is |
| | | | self-employed add lines |
| | | | all lines from tax |
| | | | reverification document |
| | | | together. Divide total |
| | | | by twelve. Follow |
| | | | rules above. |
| Was the income and | Income was | Total income. | Divide the total new |
| employment adequate | inadequate for the | Product | housing expense by the |
| for the approved | approved product | guidelines for | total income to obtain |
| product type and loan | type and loan | housing ratio | the housing ratio. To |
| parameters? | parameters. | and total debt | the housing expense |
| | | ratio. | add the total liabilities |
| | | | and divide by the |
| | | | income to obtain the |
| | | | DTI ratio. Compare |
| | | | both of these ratios to |
| | | | the product guidelines. |
| | | | If the housing ratio is |
| | | | greater than the product |
| | | | acceptable housing |
| | | | ratio by 5% or less OR |
| | | | if both ratios are equal |
| | | | to or less than the ratios |
| | | | in the product |
| | | | guidelines, indicate |
| | | | “Y”. If the DTI ratio is |
| | | | higher than the product |
| | | | guideline indicate “N”. |
| Does the file contain | File does not | Documentation | Compare checked |
| the asset | contain required | checklist of | document fields with |
| documentation as | asset documentation | asset fields. | product guidelines and |
| required in the product | as required by the | | Identify those that are |
| guidelines? | product guidelines. | | not checked against |
| | | | product guidelines. If |
| | | | any required field that |
| | | | is not checked indicate |
| | | | a “N”. If all required |
| | | | documentation is |
| | | | completed, indicate |
| | | | “Y”. |
| Were any fraud | Asset review | Fraud review | Compare list of |
| indicators associated | indicated red flags | asset issues. | resolved issues against |
| with assets resolved? | that were not | | requirements. If all |
| | resolved. | | issues checked as |
| | | | resolved, indicate “Y”. |
| | | | If not, indicate “N”:. |
| If assets include a gift, | An unacceptable | Source of | Identify type of gift |
| was it an acceptable | gift was used per | funds = gift. | funds. Compare to |
| based on product | the product | Gift type. | product guidelines for |
| guidelines? | guidelines. | Product | gift funds allowed. If |
| | | guidelines | type of funds is not |
| | | | listed within product |
| | | | guidelines indicate “N”. |
| | | | Otherwise indicate “Y”. |
| | | | Exclude question if |
| | | | loan is a cash out |
| | | | refinance loan type. |
| Was an acceptable | An unacceptable | Source of | For any loan purpose is |
| source of funds used | source of funds was | funds type. | equal to purchase or |
| in the transaction? | used in the | Product | rate and term refinance, |
| | transaction. | guidelines. | identify type of funds |
| | | | used for closing. |
| | | | Compare type of |
| | | | product guidelines. If |
| | | | not listed as acceptable |
| | | | type indicate “N:. |
| | | | Otherwise indicate “Y”. |
| Were assets calculated | Assets were | All assets | Using source of funds |
| correctly by the | calculated | dollar values | type, identify all assets |
| underwriter? | incorrectly by the | listed in | dollar values included |
| | underwriter. | application. | within this type. Add |
| | | Source of | assets together and |
| | | funds type. | compare to field of |
| | | | available assets in |
| | | | underwriting |
| | | | worksheet. If dollar |
| | | | amount is equal to the |
| | | | amount stated in |
| | | | underwriting |
| | | | worksheet, indicate |
| | | | “Y”. If not, indicate |
| | | | “N”. |
| Were assets sufficient | Assets were | Asset dollar | Compare dollar asset |
| to cover all closing | insufficient to cover | amount | amount previously |
| costs? | all closing costs. | calculated in | calculated to |
| | | previous | underwriting worksheet |
| | | question. | of amount of assets |
| | | | needed to close. If the |
| | | | calculated amount is |
| | | | equal to or greater than |
| | | | the amount of assets |
| | | | needed to close, |
| | | | indicate “Y”. If not, |
| | | | indicate “N”. |
| Is the property | The property | Property | If property addresses |
| address consistent | address is | address in | are identical indicate |
| between the | inconsistent | application. | “Y”. If not, indicate |
| application and sales | between the | Property | “N”. Exclude zip code. |
| contract? | application and | address given | |
| | sales contract | on sales | |
| | | contract. | |
| Is the property type | The property type is | Property | Compare property type |
| consistent with | not permitted in the | category type, | against product |
| acceptable property | product guidelines | product | guidelines. If property |
| types in the product | used for the loan | guidelines. | type is not included in |
| guidelines. | approval. | | guidelines, indicate |
| | | | “N”. If it is indicate |
| | | | “Y”. |
| Is the legal description | The legal | Legal | Compare property |
| and property address | description and | description and | address in title |
| consistent with the | property address are | property | commitment with |
| title report? | inconsistent with | address from | property address |
| | the title report. | title report. | included in the |
| | | Property | application. If they |
| | | address from | match indicate “Y”, if |
| | | application. If | not, indicate “N”. |
| | | available | |
| | | include legal | |
| | | description | |
| | | from | |
| | | application. | |
| Is person in title on the | Individuals in title | Legal vesting | If purchase compare |
| title report the | is inconsistent with | title held by | title vested in names |
| consistent with seller, | the title report. | field, | with sellers. If |
| if purchase; or with | | borrower(s) | refinance, compare title |
| borrower, if refinance. | | and seller(s) | vested in names with |
| | | name, loan | borrowers. If first and |
| | | purpose type | last names are not the |
| | | | same, indicated “N”. If |
| | | | they are he same |
| | | | indicate “Y”. |
| Were any red flags | Property issues | Issues reported | Review all fraud |
| associated with | indicated red flags | from fraud | findings associated |
| property issues not | that were not | company and | with property. Identify |
| resolved? | resolved. | data fields | if all have been marked |
| | | indicating | as resolved. If they |
| | | resolution.. | have indicate “Y”. If |
| | | | they have not, indicate |
| | | | “N” |
| Was a property | The property | Appraisal | Compare product |
| valuation obtained | valuation type | method type | guidelines for property |
| consistent with the | obtained is not | indicator and | valuation type with the |
| requirements of the | permitted in the | automation | appraisal type indicator |
| product investor | product guidelines | valuation | and automation |
| and/or company | used for the loan | method type. | valuation type. If they |
| standards? | approval. | Product | match, indicate “Y”. If |
| | | guidelines | they do not match |
| | | | indicate “N”. |
| Did the appraisal | The comparables | | |
| document use | used were not | | |
| acceptable | acceptable. | | |
| comparables? | | | |
| Did the appraisal | The appraisal did | Property | Obtain AVM from |
| document support the | not support the | appraised | external vendors. |
| value given? | value given on the | value type, | Compare AVM value |
| | application. | AVM high | with property appraised |
| | | value range | value type. Calculate |
| | | amount, AVM | the difference between |
| | | indicated value | them. Compare the |
| | | amount, AVM | difference with high |
| | | low value | value amount and low |
| | | range amount, | value amount. |
| | | AVM | Recalculate the LTV |
| | | confidence | based on the AVM |
| | | score indicator. | value. If difference |
| | | LTV, loam | between original LTV |
| | | amount. | and new LTV is less |
| | | | than 5% and confidence |
| | | | level is = to or greater |
| | | | than 80% indicate “Y”. |
| | | | If it is not, indicate “N:. |
| Were all adjustments | The adjustments | | |
| reasonable and the | were greater than | | |
| overall adjustments | those acceptable to | | |
| within acceptable | the product | | |
| guidelines? | guidelines. | | |
| Was the appraisal | All property data | Building status | If all fields are |
| complete with all | required for the | type, Census | complete, indicate “Y”. |
| required information | valuation was not | tract identifier, | If not, indicate “N”. |
| provided? | delivered. | condominium | |
| | | indicator, | |
| | | project | |
| | | classification | |
| | | type, property | |
| | | type, land | |
| | | estimated | |
| | | value amount, | |
| | | land trust type, | |
| | | property | |
| | | acquired date, | |
| | | property | |
| | | acreage | |
| | | number, | |
| | | property | |
| | | category type, | |
| | | property | |
| | | address, | |
| | | property | |
| | | estimated | |
| | | value amount, | |
| | | property | |
| | | financed | |
| | | number of | |
| | | units. | |
| Were any red flags | Property value data | Issues reported | If property value fields |
| associated with the | indicated red flags | from fraud | do not contain indicator |
| property valuation | that were not | company and | of resolutions, indicate |
| and/or value that were | resolved. | data fields | “N:. IF they are, |
| not resolved? | | indicating | indicate “Y”. |
| | | resolution. | |
| Does the file contain | The file does not | Loan manual | If underwriter indicator |
| evidence that it was | contain any | underwriting | or underwriting system |
| approved? | evidence that it was | indicator or | indicates “approve” or |
| | approved. | automated | “Accept” or Eligible” |
| | | underwriting | indicate “Y”. If not |
| | | system result. | indicate “N”. |
| Did underwriter | Calculations were | Total subject | Recalculate all amounts |
| complete all | not calculated | property | using new data from |
| calculations accurately | correctly and | housing | external vendors. |
| when underwriting the | impacted the | expense | Calculate housing |
| file? | acceptability of the | amount, total | expense, total debt |
| | loan within the | debt expense | ratio, total monthly |
| | product guidelines.. | ratio, total | PITI payment amount, |
| | | monthly PITI | total reserve amount. |
| | | payment | Compare total housing |
| | | amount, total | expense, total debt |
| | | reserve | ratios and total reserve |
| | | amount, Total | amount to existing |
| | | liabilities paid | numbers. If they are |
| | | amount. | the same, Indicate “Y”. |
| | | | If they are different |
| | | | compare the new |
| | | | figures to product |
| | | | guidelines. If |
| | | | difference between new |
| | | | and old is less than 5%, |
| | | | indicate “Y”. If greater |
| | | | than 5% indicate “N”. |
| Did the underwriter | Discrepancies in the | Data fields | Identify fields from |
| resolve any | file were not | from 1008 | guidelines that do not |
| discrepancies between | resolved. | form. | match the data fields. |
| and among the facts | | Underwriting | If all fields match, |
| found in the file? | | guidelines | indicate “Y”. If they do |
| | | requirements. | not match, indicate |
| | | | “N”. |
| Were all red flags in | All red flags were | Issues reported | If value fields do not |
| the file documentation | not resolved. | from fraud | contain indicator of |
| resolved? | | company and | resolution, indicate “N:. |
| | | data fields | If they do, indicate “Y” |
| | | indicating | |
| | | resolution. | |
| Were all prior to | All prior to closing | Closing | Review closing |
| closing conditions met | conditions were not | instructions | instructions condition |
| before loan was | met before loan was | condition | sequence indicator for |
| approved to close? | approved to close. | sequence | all instructions prior to |
| | | identifier | closing. Determine if |
| | | indicating | closing instructions |
| | | prior to | condition met indicator |
| | | closing. | is completed or waived. |
| | | Closing | If all are completed or |
| | | instructions | waived indicate “Y”, if |
| | | condition met | not indicate “N”. |
| | | indicator. | |
| | | Closing | |
| | | instruction | |
| | | condition | |
| | | waived. | |
| Were all at closing | All closing | Closing | Review closing |
| conditions approved | conditions were not | instructions | instructions condition |
| by underwriting prior | met prior to the | condition | sequence indicator for |
| to funds being | disbursement of | sequence | all instructions for “at” |
| disbursed? | funds. | identifier | closing. Determine if |
| | | indicating | closing instructions |
| | | prior to | condition met indicator |
| | | closing. | is completed or waived. |
| | | Closing | If all are completed or |
| | | instructions | waived indicate “Y”. If |
| | | condition met | not indicate “N” |
| | | indicator. | |
| | | Closing | |
| | | instruction | |
| | | condition | |
| | | waived. | |
| If an underwriting | Loan did not meet | Underwriter | Compare 1008 loan |
| exception was granted, | guidelines and was | code. | fields against |
| was it properly | approved without | Guidelines for | underwriting |
| documented per | additional approved | underwriting | guidelines. If data is |
| policy? | authority. | authority | greater than |
| | | levels. Loan | corresponding data in |
| | | 1008 fields | guidelines compare the |
| | | | fields and calculate the |
| | | | difference. If DTI ratio |
| | | | and reserve ratios are |
| | | | equal, less than or no |
| | | | greater than 10% more |
| | | | than the guidelines, |
| | | | indicate “Y”. If they |
| | | | are not, review |
| | | | underwriter code |
| | | | authority level. If |
| | | | authority level is equal |
| | | | to or greater than loan |
| | | | amount, indicate “Y”. |
| | | | If it is not, indicate “N”. |
| Did the underwriter | Underwriter | Underwriter | Compare 1008 loan |
| have the appropriate | authority level was | code. | fields against |
| authority to sign off on | exceeded | Guidelines for | underwriting |
| the file and/or any | | underwriting | guidelines. If data is |
| waiver of conditions | | authority | greater than |
| found in the file? | | levels. Loan | corresponding data in |
| | | 1008 fields | guidelines compare the |
| | | | fields and calculate the |
| | | | difference. If DTI ratio |
| | | | and reserve ratios are |
| | | | equal, less than or no |
| | | | greater than 10% more |
| | | | than the guidelines, |
| | | | indicate “Y”. If they |
| | | | are not, review |
| | | | underwriter code |
| | | | authority level. If |
| | | | authority level is equal |
| | | | to or greater than loan |
| | | | amount, indicate “Y”. |
| | | | If it is not, indicate “N”. |
| Does the loan data in | Data between the | Data from | Compare each data |
| the system match the | system and the AUS | AUS system. | field. If data matches |
| data feedback from the | system was | Updated data | indicate “Y”. If it does |
| automated | inconsistent. | from external | not, indicate “Y”. |
| underwriting system? | | vendors. | |
| Does the loan approval | The loan approval | Underwriting | Compare data fields. If |
| meet the requirements | does not meet the | guidelines. | data from system does |
| for the product type | product guideline | Loan data from | not match the data from |
| chosen? | requirements. | 1008. | guidelines, indicate |
| | | | “N”. If is equal to or |
| | | | better than guideline |
| | | | data, indicate “Y”. |
| Is the title | The title report | Title report | Review all title report |
| commitment free of | shows that issues | items | items. If indicator is |
| any liens or | that cloud the title | description | “N” and does not have |
| encumbrances that | were not resolved. | with | corresponding |
| cloud the lenders lien | | acceptability | endorsements |
| position? | | indicator. Title | description indicator, |
| | | report | indicate “N”. If does |
| | | endorsements | have the endorsement |
| | | description. | description indicator |
| | | | checked indicate “Y”. |
| If available, was an | The system does not | | |
| insured closing letter | indicate that an | | |
| in the file from the | acceptable insured | | |
| company providing | closing letter was | | |
| title coverage and | obtained. | | |
| insuring the closing | | | |
| agent to whom the | | | |
| funds were sent. | | | |
| Did the closing | All required closing | Closing | Review closing |
| instructions address all | conditions were not | instruction | instructions condition |
| appropriate title and | included in the | condition | sequence indicator for |
| underwriting risks as | closing instruction. | description. | all instructions for “at” |
| documented in the | | Underwriting | closing. Determine if |
| file? | | conditions. | closing instructions |
| | | | condition met indicator |
| | | | is completed or waived. |
| | | | If all are completed or |
| | | | waived indicate “Y”. If |
| | | | not indicate “N” |
| Were all appropriate | All required | Data elements | Review data document |
| closing documents | documents were not | from closing- | set to data elements |
| included based on | included in the | Items 1-67. | from closing. If |
| selected loan | closing package. | Data document | documents required |
| program? | | set attached to | from document set are |
| | | loan type. | not included in |
| | | | document indicator, |
| | | | indicate “N”. If all |
| | | | documents are |
| | | | included, indicate “Y”. |
| Was the data included | There were | Data elements | Review data from |
| in the documents | inaccuracies in the | from closing- | document set against |
| consistent with the | closing documents. | Items 1-67. | data set. If differences |
| parameters of the | | Data document | in data used in closing |
| approved loan product. | | set attached to | document set from |
| | | loan type. | other data in system, |
| | | Total loan data | indicate “N”. If data |
| | | set. | matched, indicate “Y”. |
| Was the final TIL | The TIL calculation | Note date, note | Send data to regulatory |
| accurate based on the | was inaccurate | rate percent, | vendor to recalculate |
| selected loan | based on the | all fees with | APR. IF result in |
| program? | selected loan | borrower paid | accurate, indicate “Y”. |
| | program. | indicator, loan | If result is inaccurate or |
| | | type, loan | if result indicates a |
| | | term, MI | “High Cost” loan, |
| | | payments. | indicate “N”. |
| Was an accurate HUD | The HUD 1 fees | All fees with | Compare fees in good |
| I based on the fees and | were in excess of | payment | faith and system. |
| charges in the system | the fees and charges | indicator. Fees | Using the higher of the |
| included in the file? | associated with the | from system | two, compare these to |
| | selected loan | for property | the fees indicated for |
| | product. | location and | the HUD #1. Compare |
| | | fees included | payee type for each fee, |
| | | in Good Faith. | If fee amount and |
| | | | payee type agree, |
| | | | indicate ok. If they do |
| | | | not agree, indicate no. |
| | | | If all fees agree indicate |
| | | | “Y” in the program. If |
| | | | they do not agree, |
| | | | indicate “N”. |
| Does the loan violate | The recalculation of | Note date, note | Send data to regulatory |
| the TIL High Cost | the TIL indicates | rate percent, | vendor to recalculate |
| loan requirements? | that the High Cost | all fees with | APR. IF result in |
| | loan limitations | borrower paid | accurate, indicate “Y”. |
| | were exceeded. | indicator, loan | If result indicates a |
| | | type, loan | “High Cost” loan, |
| | | term, MI | indicate “N”. |
| | | payments. | |
| Does the file contain | There is inadequate | Hazard | Subtract the land value |
| evidence of adequate | hazard insurance on | insurance | from the estimated |
| hazard insurance on | the property. | coverage and | value. Insurance |
| the subject property as | | hazard | coverage should cover |
| required? | | insurance | the lesser of the |
| | | escrowed | calculated number or |
| | | indicator. | the loan amount. If it |
| | | Loan amount. | does indicate “Y”. If it |
| | | Estimated land | doesn't indicate “N”. |
| | | value amount. | |
| | | Property | |
| | | appraised | |
| | | value amount. | |
| Does the file contain | There is inadequate | Flood | Subtract the land value |
| evidence of adequate | flood insurance in | insurance | from the estimated |
| flood insurance on the | the file. | coverage | value. Insurance |
| subject property if | | amount and | coverage should cover |
| required? | | escrow | the lesser of the |
| | | indicator. | calculated number, the |
| | | Loan amount. | loan amount be for |
| | | Estimated land | $250,000, whichever is |
| | | value amount. | lower. If it does |
| | | | indicate “Y”. If it |
| | | | doesn't indicate “N”. |
| If escrows were not | Escrow waivers | Escrow waiver | If escrow waiver |
| collected, were | were required and | indicator. | indicator is not checked |
| appropriate waiver | not included. | | and funds were not |
| documents signed? | | | collected, indicate “N”. |
| | | | If the indicator is not |
| | | | checked and funds were |
| | | | collected or if the |
| | | | indicator is checked |
| | | | and no funds were |
| | | | collected, indicate “Y”. |
| If loan is a refinance, | An acceptable | Document set, | If loan purpose is |
| does the file contain | recession notice was | loan purpose, | refinance and |
| an acceptable | required and not | occupancy | occupancy type is |
| rescission notice? | included. | type. | primary, determine if |
| | | | doc set includes a |
| | | | rescission notice. If it |
| | | | does, indicate “Y”, if it |
| | | | does not indicate “N”. |
| Were funds disbursed | Appropriate | Loan purpose, | If loan type is refinance |
| prior to the end of the | recession period | close date, | and occupancy type is |
| recession period? | was not provided. | rescission date, | primary calculate the |
| | | occupancy | rescission period by |
| | | type. | adding three days to the |
| | | | day following the |
| | | | closing date. Do not |
| | | | included Sundays or |
| | | | Federal holidays. If |
| | | | disbursement date is |
| | | | less than calculated |
| | | | date, indicate “N”. If it |
| | | | is equal to or greater |
| | | | than calculated date, |
| | | | indicate “Y”. |
| Does the file contain | There is no | Disbursement | If loan data includes a |
| evidence the loan was | evidence that the | date, | disbursement date and |
| approved for funding? | loan was approved | authorization | authorization to fund is |
| | for funding. | to fund date. | blank, indicate “N”. If |
| | | | loan data includes a |
| | | | disbursement and |
| | | | authorization to fund is |
| | | | completed with code |
| | | | for individual with |
| | | | authority to authorize |
| | | | funding, indicate “Y”. |

### EXAMPLES

### Example 1

### Process Variations

Loan underwriting and closing process steps can be executed incorrectly in a number of ways, resulting in process variations. See Table 2 for examples of process variations. One example of a process variation is the failure to obtain valid income data or the acceptance of data that has not been substantiated. This type of process variation is known as “misinformation.” The risk associated with this process variation is that the income data is inaccurate, making all of the calculations involved in the underwriting process and the resulting decision invalid. This creates the risk that the applicant will not be able to make the loan payments and default on the loan. When determining what process variations occurred and recording these process variations, this process variation would be recorded as “Documentation used to calculate income was inadequate or inconsistent with verified source.”

Another process variation is the inaccurate calculation of the borrower's income provided. For example, if the applicant is a teacher and is paid on a 10 month basis, the yearly income should still be divided by 12. If it is instead divided by 10, the amount of income available for housing expense is inflated. This type of process variation is known as “miscalculation.” This creates a risk similar to having inaccurate data and may have an impact on how the loan will perform (whether or not the loan will default). This process variation would be recorded as “The income was calculated incorrectly.”

Yet another type of process variation that can occur is the incorrect application of underwriting guidelines. This type of process variation is known as “misapplication.” In this case, misapplication would occur if, after accurately obtaining the income data and calculating it correctly, the underwriter approved the loan when the resulting housing ratio was 40% and the investor guidelines stated that it could be no more than 35%. Once again, this process variation contributes to the risk that the applicant will not be able to make the necessary loan payments and default on the loan. This process variation would be recorded as “Income was inadequate for the approved loan type and loan parameters.”

### Example 2

### Calculating the Risk for Two Loans

An investor is reviewing two loans for purchase. Both loans have the following characteristics:

conventional, fixed rate 30 year, 75% LTV, full documentation, 620 FICO score.

At first glance, these loans appear identical and would most likely be purchased for the same price. However, one loan has two process variations, one for failing to calculate the income correctly and one for failing to require sufficient funds to close the loan. Because both of these process variations are frequently associated with defaulted loans, the process risk score for this loan is 10. The other loan has only one process variation related to the timing of the early regulatory disclosure package which has rarely been associated with a defaulted loan. As a result, the process score for this loan is 85. When these scores are added to the individual loan data listed above, it is evident that the loan with the process score of 10 has a significantly higher default probability and therefore would warrant a lower price in the market.

### Example 3

### Testing the Validity of a Financial Risk Score

In order to test the validity of a financial risk score generated by the systems and methods of the invention, loans were manually evaluated. In the first step, the required data was obtained using the actual loan files. This data is equivalent to the data that would be sent to the database of the system. In the second step, the data was used to obtain external data from various databases. In the third step, using the loan data and the data obtained from external sources, the IF-THEN rules were applied. In the fourth step, once the “Y”s and “N”s were determined, the statistical model was applied. In the last step, the score was then calculated.

Based on this process there were two loans that had the highest probability of default. Because the model is based on the probability of loans being more than 90 days delinquent, these loans, that were made within the four previous months, did not have the possibility of reaching the more than 90 day delinquent status at the time of the review. However, a review of the payment history was conducted to determine if there had been any delinquency issues to date. This review showed that both loans had a delinquency of one month. In other words, they were at least 31 days late in paying the monthly payment. A summary of these loans is shown in Table 3. The remaining loans with score ranges from 34 to 100 were all performing (i.e., had no delinquency issues) at the time of the review.

TABLE 3

| Loan 1 Attributes: | Loan Amount- $576,000 | LTV: 80% |
|---|---|---|
| | Purpose: Purchase | Property: SFD |
| Score: 0 | | |
| Process | Red flags that indicate credit fraud were not resolved. | |
| variations: | Source of income was inconsistent with the | |
| | source of income verified. | |
| | Income was unreasonable for the type of employment. | |
| | Fraud indicators associated with the assets used | |
| | were not addressed. Red flags associated with | |
| | the property were not resolved (property was | |
| | sold within the last six months). | |
| | The appraisal did not support the value. | |
| | The underwriter did not resolve discrepancies in the | |
| | file. | |
| Payment Status: | One time thirty days late. | |
| Loan 2 Attributes: | Loan Amount- $111,112 | LTV: 97% |
| | Purpose: Purchase | Property: SFD |

| | |
|---|---|
| Score: 13 | |
| Process | Consumer disclosures were not provided as required. |
| Variations: | Discrepancies in the credit report were not resolved. |
| | Income was unreasonable for the type and location |
| | of employment. Fraud indicators associated with |
| | the assets were not addressed. Person in title |
| | was inconsistent with the name of the seller. |
| | Comparable property adjustments on the appraisal |
| | were not within the acceptable guidelines. |
| | The underwriter did not resolve the discrepancies |
| | in the file. |
| Payment Status: | One time thirty days late |

### Other Embodiments

While the above description contains many specifics, these should not be construed as limitations on the scope of the invention, but rather as examples of preferred embodiments thereof Many other variations are possible. For example, although the description of the invention focuses on assessing financial risk associated with mortgages, the invention could also be used to assess financial risks associated with other types of loans. As another example, although the description of the invention focuses on MLLR as the computer-implemented statistical method used for generating a financial risk score, any suitable statistical method can be used. Accordingly, the scope of the invention should be determined not by the embodiments illustrated, but by the appended claims and their legal equivalents.

What is claimed is:

1. A method for assessing a particular loan's financial risk, the method comprising the steps of:
(a) providing a predictive model based on a plurality of loans that have been deemed delinquent;
(b) acquiring data pertaining to a borrower who has obtained a particular loan and data pertaining to the particular loan;
(c) processing the acquired data to identify process variations; and
(d) applying the predictive model to the processed data pertaining to the borrower and to the particular loan to generate a financial risk score for the particular loan.

2. The method of claim 1, further comprising the step (e) of use of the generated financial risk score by an entity who is interested in purchasing the particular loan to determine whether or not to purchase the particular loan.

3. The method of claim 1, wherein at least one of the steps is implemented on a computer.

4. The method of claim 1, wherein the steps (c) of processing the acquired data to identify process variations and (d) of applying the predictive model to the processed data pertaining to the borrower and to the particular loan to generate a financial risk score for the particular loan are performed using a computer-implemented algorithm.

5. The method of claim 1, wherein the plurality of loans that have been deemed delinquent have been delinquent for at least 90 days.

6. The method of claim 1, wherein the particular loan is a property or housing loan.

7. The method of claim 1, wherein the data pertaining to the borrower comprises income information and credit information.

8. The method of claim 1, wherein the data pertaining to the particular loan comprises loan amount, interest rate, and type of loan.

9. The method of claim 8, wherein the data pertaining to the particular loan further comprises information pertaining to each step involved in underwriting and closing the particular loan.

10. The method of claim 1, wherein the generated financial risk score is a number between 0 and 100.

11. A system for assessing a particular loan's financial risk, the system comprising:
(a) a means for acquiring and processing data pertaining to a borrower who has obtained a particular loan and data pertaining to the particular loan;
(b) a means for applying a predictive model based on a plurality of loans that have been deemed delinquent to the processed data to generate a financial risk score for the particular loan.

12. The system of claim 11, wherein the means for acquiring and processing data pertaining to a borrower who has obtained a particular loan and data pertaining to the particular loan comprises a computer-implemented, rules-based statistical algorithm.

13. The system of claim 12, wherein the computer-implemented, rules-based statistical algorithm is executed by an Artificial Intelligence system.

14. The system of claim 11, wherein the means for applying the predictive model to the processed data to generate a financial risk score for the particular loan comprises a statistical algorithm.

15. The system of claim 14, wherein the statistical algorithm comprises Maximum Likelihood Logistic Regression.

16. The system of claim 11, wherein the particular loan is a property or housing loan.

17. The system of claim 11, wherein the data pertaining to the borrower comprises income information and credit information.

18. The system of claim 11, wherein the data pertaining to the particular loan comprises loan amount, interest rate, and type of loan.

19. The system of claim 11, wherein the data pertaining to the particular loan further comprises information pertaining to each step involved in underwriting and closing the particular loan.

20. The system of claim 11, wherein the generated financial risk score is a number between 0 and 100.

21. The system of claim 11, further comprising (c) a database storing thereon the data pertaining to the borrower, the data pertaining to the particular loan, and the predictive model.

22. A computer-readable medium comprising instructions coded thereon that, when executed on a suitably programmed computer, execute the step of applying a predictive model based on a plurality of loans that have been deemed delinquent to processed data pertaining to a borrower of a particular loan and data pertaining to the particular loan to generate a financial risk score for the particular loan.

23. The computer-readable medium of claim 22, wherein the plurality of loans that have been deemed delinquent have been delinquent for at least 90 days.

24. The computer-readable medium of claim 23, wherein the particular loan is a property or housing loan.

25. The computer-readable medium of claim 23, wherein the data pertaining to the borrower comprises income information and credit information.

26. The computer-readable medium of claim 23, wherein the data pertaining to the particular loan comprises loan amount, interest rate, and type of loan.

27. The computer-readable medium of claim 26, wherein the data pertaining to the particular loan further comprises information pertaining to each step involved in underwriting and closing the particular loan.

28. The computer-readable medium of claim 23, wherein the generated financial risk score is a number between 0 and 100.
